(19) United States
(12) Patent Application Publication
(10) Pub. No.: US 2002/0146624 A1
(43) Pub. Date: Oct. 10, 2002

(54) Hydrogen-storage material

(76) Inventors: Hajime Goto, Saitama (JP); Terumi Furuta, Saitama (JP); Toshio Tokune, Saitama (JP); Yoshiya Fujiwara, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/079,816

(22) Filed: Feb. 22, 2002

(30) Foreign Application Priority Data
Feb. 23, 2001 (JP) 2001-049327
Nov. 7, 2001 (JP) 2001-342124

(51) Int. Cl. H01M 4/58; H01M 4/62

(52) U.S. Cl. 429/218.2; 429/232; 252/182.1

(57) ABSTRACT

A hydrogen-storage material includes a plurality of carbon carriers made of a carbon material having an electric conductivity, and a plurality of fine particles carried on each of the carbon carriers and having a hydrogen-adsorbing ability. The amount A of fine particles carried is in a range of 0.1% by weight≦A≦20% by weight. The fine particles are at least one selected from fine particles of a metal, fine particles of an alloy and fine particles of an oxide semiconductor. For example, the alloy corresponds to an alloy made of at least one selected from the group consisting of Mg, Ti, a rare earth element, Zr, V, Ca and Al, and at least one selected from the group consisting of Fe, Co, Ni, Cu, Mn, Mo and W. Thus, the hydrogen-storage material is relatively light; has a high hydrogen-storing ability at ambient temperature and under a lower hydrogen pressure; and moreover, exhibits hydrogen-absorbing/releasing rates.

### BACKGROUND OF THE INVENTION

1. Field of the Invention

The present invention relates to a hydrogen-storage material, e.g., a hydrogen-storage material suitable for use in a hydrogen-storage vessel in a vehicle having a fuel cell mounted thereon.

2. Description of the Related Art

A conventionally known hydrogen-storage material comprises a porous carbon material having a metal film which is formed on a surface thereof and which has a function to dissociate each of hydrogen molecules into hydrogen atoms, so that the hydrogen atoms are adsorbed not only to a surface of the porous carbon material but also to the inside thereof (see Japanese Patent Application Laid-open No. 10-72201).

However, the conventionally known hydrogen-storage material suffers from the following problems: the number of hydrogen-adsorbing sites on the carbon material is reduced, because the surface of the porous carbon material is coated with the metal film; when hydrogen is adsorbed and released, it is required that the hydrogen atoms are diffused in the metal film and hence, the rates of absorption and release of hydrogen are reduced correspondingly; when hydrogen is absorbed, it is necessary to cool the hydrogen-storage material down to about −196° C., which is a temperature of liquid nitrogen, and a high hydrogen pressure equal to or higher than 3 MPa and preferably equal to or higher than 5.1 MPa is required, resulting in an increase in equipment cost.

### SUMMARY OF THE INVENTION

Accordingly, it is an object of the present invention to provide a hydrogen-storage material, which is relatively light and which has a high hydrogen-storing ability at ambient temperatures and under low hydrogen pressures, and exhibits high hydrogen-absorbing/releasing rates.

To achieve the above object, according to the present invention, there is provided a hydrogen-storage material comprising a plurality of carbon carriers made of a carbon material having an electric conductivity, and a plurality of fine particles carried on each of the carbon carriers and having a hydrogen-adsorbing ability. The amount A of the fine particles carried is in a range of 0.1% by weight≦A≦20% by weight. The fine particles is at least one selected from fine particles of a metal, fine particles of an alloy and fine particles of an oxide semiconductor. The metal is at least one selected from the group consisting of V, Nb, Ta, Ti, Zr, Hf, La and Ce. The alloy is an alloy made of at least one selected from the group consisting of Mg, Ti, a rare earth element, Zr, V, Ca and Al and at least one selected from the group consisting of Fe, Co, Ni, Cu, Mn, Mo and W. The oxide semiconductor is at least one selected from the group consisting of an Ni oxide semiconductor, a Cr-oxide semiconductor, a Cu-oxide semiconductor, an Mn-oxide semiconductor, an Sn-oxide semiconductor, a Zn-oxide semiconductor, a V-oxide semiconductor, a Ti-oxide semiconductor, a Co-oxide semiconductor and an Fe-oxide semiconductor.

As described above, if the hydrogen-storage material is formed from the plurality of carbon carriers and the plurality of fine particles carried on each of the carbon carriers, it is possible to achieve a reduction in weight of the hydrogen-storage material.

Each of the fine particles of the above formation attracts electron(s) from one hydrogen molecule or a plurality of hydrogen molecules deposited on a surface of the fine particle at ambient temperature and under a low hydrogen pressure to adsorb one or more hydrogen molecules in ionic state(s), and attracts electron(s) from one hydrogen molecule or a plurality of hydrogen molecules in the vicinity of each of the fine particles deposited on the surface of the electrically conductive carbon carriers through each of the carbon carriers to adsorb one or more hydrogen molecules in ionic state(s). The attraction of electron(s) through the carbon carrier also occurs with respect to the hydrogen molecules deposited on both the surface of the fine particle and the surface of the carbon carrier. In this case, it is possible to widely ensure hydrogen-adsorbing sites on the surface of the carbon carrier by setting the amount of fine particles carried in the above-described range.

With the above-described hydrogen-adsorbing mechanism, the hydrogen-storage material exhibits a high hydrogen storing ability at ambient temperature and under a low hydrogen pressure. In addition, hydrogen is adsorbed directly to the surfaces of the fine particles and the surfaces of the carbon carrier and hence, the hydrogen-adsorbing rate is high. Moreover, the hydrogen is desorbed easily from the surfaces by heating (or depressurization) and hence, the hydrogen-releasing rate is high.

However, if the amount A of fine particles carried is lower than 0.1% by weight, the distance between the adjacent fine particles is increased, so that a portion incapable of being involved in the adsorption of hydrogen is created in a region existing between these fine particles on the carbon carrier. This is because the thickness of an electron accumulation layer and an electron depletion layer formed between each of the fine particles and the carbon is limited. On the other hand, if A>20% by weight, the number of hydrogen-adsorbing sites on the surface of the carbon carrier is reduced.

The above and other objects, features and advantages of the invention will become apparent from the following description of the preferred embodiment taken in conjunction with the accompanying drawings.

### BRIEF DESCRIPTION OF THE DRAWINGS

FIG. 1 is a diagram for explaining a hydrogen-storage material;

FIG. 2 is a diagram showing a state in which hydrogen is being supplied to the hydrogen-storage material;

FIG. 3 is a diagram showing a state in which hydrogen is deposited to the hydrogen-storage material;

FIG. 4 is a diagram showing a state in which hydrogen is electrically adsorbed to the hydrogen-storage material;

FIG. 5 is a sectional view of a consumable electrode;

FIG. 6 is a diagram for explaining an arc discharge type carbon nano-tube producing apparatus;

FIG. 7 is a graph showing the relationship between the hydrogen pressure in a vessel and the amount of hydrogen stored for Embodiment 1;

FIG. 8 is a graph showing the relationship between the hydrogen pressure in a vessel and the amount of hydrogen stored for Embodiment 2;

FIG. 9 is a graph showing the relationship between the hydrogen pressure in a vessel and the amount of hydrogen stored for Embodiment 3; and

FIG. 10 is a graph showing the relationship between the average particle size d of TiNi particles and the amount of hydrogen stored.

### DESCRIPTION OF THE PREFERRED EMBODIMENT

The present invention will now be described by way of an embodiment with reference to the accompanying drawings.

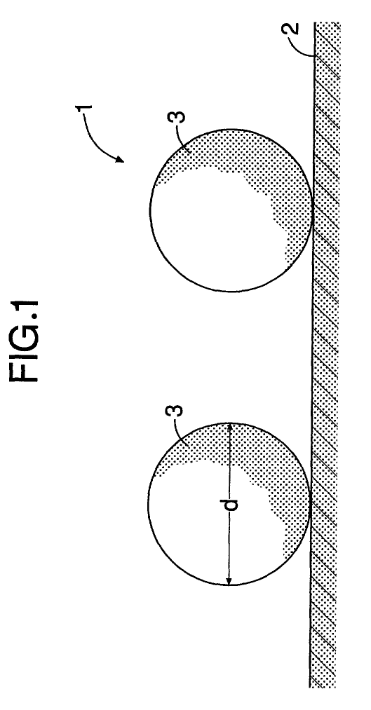

Referring to FIG. 1, a hydrogen-storage material 1 comprises a plurality of carbon carriers 2 made of a carbon material having an electric conductivity, and a plurality of fine particles 3 carried on each of the carbon carriers 2 and having a hydrogen absorbing ability. An amount A of fine particles 3 carried is set in a range of 1% by weight≦A≦20% by weight.

The fine particles 3 are at least one selected from fine particles of a metal, fine particles of an alloy and fine particles of an oxide semiconductor. The metal corresponds to at least one selected from the group consisting of V, Nb, Ta, Ti, Zr, Hf, La and Ce. The alloy corresponds to an alloy made of at least one selected from the group consisting of Mg, Ti, a rare earth element, Zr, V, Ca and Al and at least one selected from the group consisting of Fe, Co, Ni, Cu, Mn, Mo and W. Further, the oxide semiconductor corresponds to at least one selected from the group consisting of an Ni-oxide semiconductor, a Cr-oxide semiconductor, a Cu-oxide semiconductor, an Mn-oxide semiconductor, an Sn-oxide semiconductor, a Zn-oxide semiconductor, a V-oxide semiconductor, a Ti-oxide semiconductor, a Co-oxide semiconductor and an Fe-oxide semiconductor.

The carbon carrier 2 preferably has a large specific surface area from the viewpoints of the carrying of the fine particles 3 and the adsorption of hydrogen. At least one selected from the group consisting of activated carbon, nano-tube and fullerene, each of which is a porous carbon material, may be used as the carbon carrier 2. Carbon black may also be used as the carbon carrier 2.

If the hydrogen-storage material 1 is formed from the plurality of the carbon carriers 2, and the plurality of the fine particles 3 carried on each of the carbon carriers 2, as described above, it is possible to achieve a reduction in weight of the hydrogen-storage material 1.

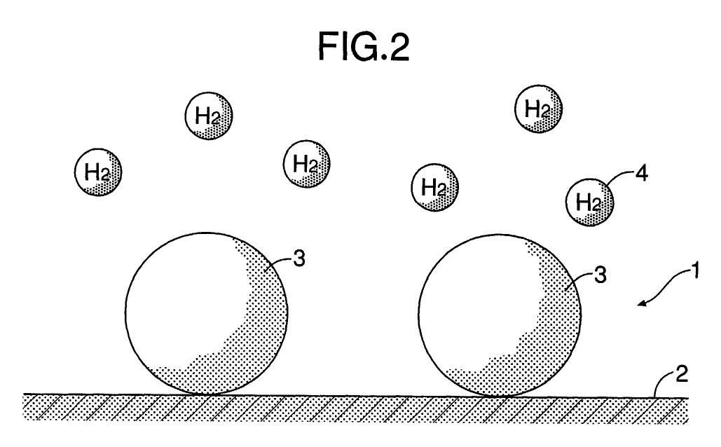

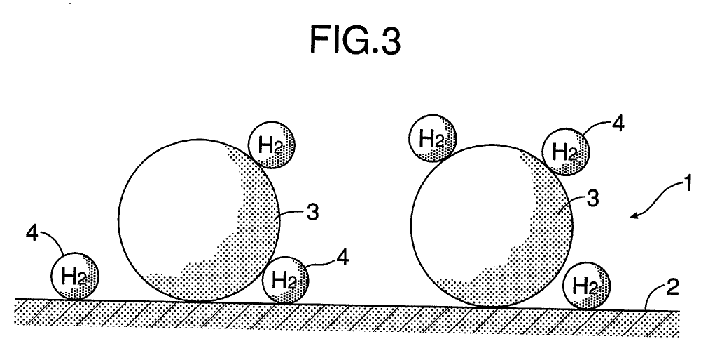

During storage of hydrogen, hydrogen 4 of a low pressure, e.g., 1 MPa or less is supplied to the hydrogen-storage material placed in a vessel and having ambient temperature, e.g., 25° C., as shown in FIG. 2. Thus, one hydrogen molecule or a plurality of hydrogen molecules 4 are deposited on surfaces of the fine particles 3 and a surface of the carbon carrier 2, as shown in FIG. 3.

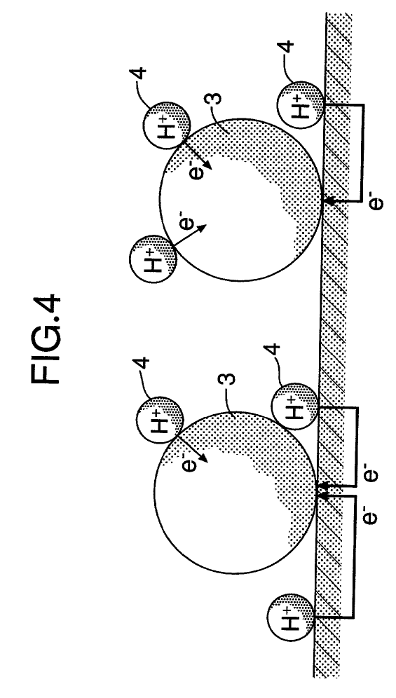

As shown in FIG. 4, each of the fine particles 3 attracts electron(s) e⁻ from one or a plurality of hydrogen molecules 4 deposited to its surface at ambient temperature and under a low hydrogen pressure to adsorb one or a plurality of hydrogen molecules 4 in ionic state(s), and attracts electron(s) e⁻ from one or a plurality of hydrogen molecules 4 in the vicinity of each of the fine particles 3 deposited to the surface of the electrically conductive carbon carrier 2 through the carbon carrier 2, thereby adsorbing one or more hydrogen molecules 4 in ionic state(s) to the surface of the carbon carrier 2. The attraction of electron(s) e⁻ through the carbon carrier 2 also occurs with respect to the hydrogen molecules 4 deposited to both of the surface of the fine particle 3 and the surface of the carbon carrier 2. In this case, it is possible to widely ensure hydrogen-adsorbing sites on the surface of the carbon carrier 2 by setting the amount of fine particles 2 carried in the above-described range.

With the above-described hydrogen-adsorbing mechanism, the hydrogen-storage material 1 exhibits a high hydrogen storing ability at ambient temperature and under a low hydrogen pressure. The hydrogen molecules 4 are adsorbed directly to the surfaces of the fine particles and the surfaces of the carbon carriers 2 and hence, the hydrogen-adsorbing rate is high. Moreover, the hydrogen molecules 4 are desorbed easily from the surfaces by heating (or depressurization) and hence, the hydrogen-releasing rate is high.

An average particle size d of the fine particles 3 is set at a value equal to or smaller than 1 μm (d≦1 μm). However, if d>1 μm, an increase in weight of the hydrogen-storage material is brought about and for this reason, an advantage of weight reduction cannot be obtained. A lower limit value for the average particle size d of the fine particles 3 is preferably 1 nm. If d<1 μm, in the fine particles 3, the proportion of its surface layer portion having incomplete crystals increases relative to its interior having a high crystallinity. Therefore, the crystallinity of the fine particles 3 is deteriorated as a whole, whereby the effective exchange of electrons becomes impossible.

Particular examples will be described below.

### EXAMPLE-I

A. Production of Carbon Nano-Tube

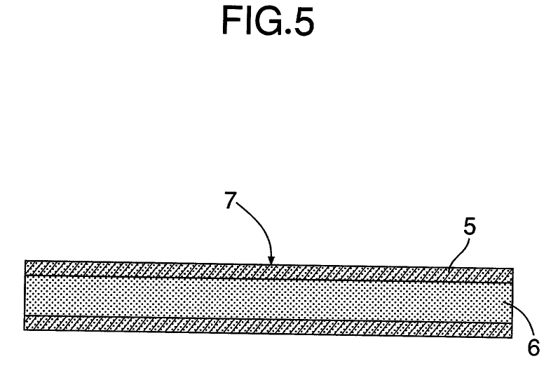

(1) As shown in FIG. 5, a high-purity graphite tube 5 having an outer diameter of 6 mm, an inner diameter of 3 mm and a length of 150 mm was prepared.

(2) A catalyst 6 was made by mixing powders of Ni, Y, Ti and C (graphite) so that the resultant ratio of constituents (Ni:Y:Ti:C) was 2:2:2:94 by weight. The catalyst 6 was packed into the high-purity graphite tube 5 to fabricate a consumable electrode 7.

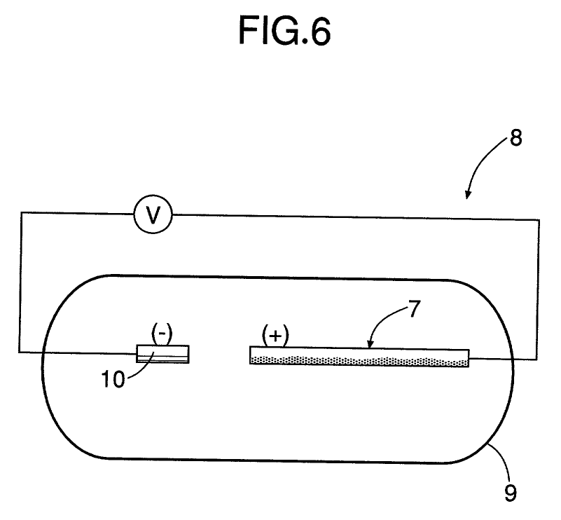

(3) As shown in FIG. 6, the inside of a chamber 9 of an arc discharge type carbon nano-tube producing apparatus 8 was evacuated by vacuum and then charged with high-purity helium, whereby the chamber pressure was regulated to a producing pressure of 0.06 MPa.

(4) The consumable electrode 7 serving as a plus (+) pole was automatically fed in such a manner that the voltage and the current were constant at 35 V and 100 A by a voltage feedback control, whereby an arc discharge was generated between the consumable electrode 7 and an electrode 10 serving as a minus (−) pole. The consumable electrode 7 was consumed by such arc discharge to produce soot.

(5) The thus-synthesized types of soot: the soot deposited to an inner wall of the chamber, the soot accumulated on a bottom wall of the chamber and the cobweb-like soot were recovered separately, and their weights were recorded. It was ascertained that, among these types of soot, the cobweb-like soot contained the largest amount of carbon nano-tubes. It was also ascertained that the outer diameter D of the carbon nano-tube obtained in the above manner was in a range of 1.2 nm≦D≦1.6 nm.

B. Production of Hydrogen-Storage Material

[B-1]

(1) 22.8 mg of an LaCl₃ powder and 59.2 mg of an NiCl₂ powder were weighed so that La:Ni=1:5 by weight, and dissolved into 50 cc of distilled water to provide a solution. (2) 34 mg of Na₂CO₃ was added to and mixed with the solution to provide a precipitate (carbonate). (3) The precipitate was filtered off and then subjected sequentially to a drying treatment at 80° C. for 1 hour and a calcining treatment at 600° C. for 1.5 hours to provide a composite oxide. (4) 60 mg of CaH₂ was added to 38 mg of the composite oxide to prepare a mixture, and then the mixture was subjected to a heating treatment at 950° for 1 hour in an atmosphere of hydrogen to provide a product. (5) The product was subjected twice to a washing treatment using distilled water and then to a drying treatment at 80° for 1 hour. (6) 74 mg of the product and 80 mg of the above-described carbon tubes were placed in 2 N hydrochloric acid, and then ultrasonic wave was applied to the resulting solution to disperse the product in the solution and to remove a calcium compound from the product. (7) Solids were filtered off and subjected twice to a washing treatment using distilled water and then to drying treatment at 80° for 1 hour.

A hydrogen-storage material having the carbon nano-tubes serving as the carbon carriers and particles of LaNi₅ which serves as the fine particles and which are carried on the carbon nano-tube, was produced through the above-described steps. It was found, from a thermal analysis, that the amount A of the LaNi₅ particles in the hydrogen-storage material was 20% by weight. It was also found that the particle size D of the LaNi₅ particles was in a range of 10 nm≦D≦1 μm from the result of the TEM and SEM observation and that the average particle size d was 0.5 μm from the calculation based on the above result. This hydrogen-storage material is called Embodiment 1.

[B-2]

(1) 5 mg of an NiCl₂ powder and 4 mg of an Mg powder were incorporated into 10 cc of dimethyl formamide to provide a solution. (2) 100 mg of the carbon nano-tubes were mixed with the solution to provide a dispersion. (3) NiBr₂ and methyl cyanide were added to and mixed with the dispersion to provide a precipitate. (4) The precipitate was filtered off and then subjected sequentially to a drying treatment at 80° C. for 1 hour and then to a heating treatment at 560° C. for 2 hours in an atmosphere of argon.

A hydrogen-storage material having the carbon nano-tubes serving as the carbon carriers and particles of LaNi₅ which serves as the fine particles and which are carried on the carbon nano-tube, was produced through the above-described steps. It was found from the result of a thermal analysis that the amount A of particles of Mg₂Ni carried in this hydrogen-storage material was equal to 0.5% by weight. It was also found that the particle size D of the particles of LaNi₅ was in a range of 1 nm≦D≦1 μm from the result of the TEM and SEM observation and that the average particle size d was equal to 0.3 μm from the calculation based on the above result. This hydrogen storage material is called Embodiment 2.

[B-3]

(1) A mixture of 1.4 g of TiCl₄ and 1.3 g of NiCl₂ was hydrolyzed to provide a precipitate (a composite oxide hydrate). (2) The precipitate was filtered off and then subjected sequentially to a drying treatment at 80° C. for 1 hour and to a calcining treatment at 600° C. for 1.5 hours to provide a composite oxide anhydrate. (3) 3 g Of CaH₂ was added to 1.5 g of the composite oxide anhydrate to prepare a mixture, and then the mixture was subjected to a heating treatment at 900° C. for 0.5 hour in an atmosphere of hydrogen to provide a powder. (4) The powder was subjected twice to a washing treatment using distilled water and then to a drying treatment at 80° C. for 1 hour.

The powder produced in the above manner was subjected to an analysis using SEM-EDX. As a result, it was found that the powder comprises an aggregate of TiNi particles, TiO₂ particles and NiO particles. It was also found that the particle size D of the aggregate was in a range of 50 nm≦D≦1 μm from the result of the TEM and SEM observation, and that the average particle size d was equal to 0.6 μm from the calculation based on the above result.

Then, 10 mg of the powder and 90 mg of activated carbon were mixed together, so that the content of the powder comprising the aggregate of the particles TiNi, the particles of TiO₂ and the particles of NiO was 10% by weight. Subsequently, the resultant mixture was subjected to a low-energy ball milling in an atmosphere of argon to provide a hydrogen-storage material having the TiNi particles, the TiO₂ particles and the NiO particles each serving as the fine particles on the activated carbon serving as the carbon carrier. It was found, from a thermal analysis, that the amount A of powder carried in the hydrogen-storage material was equal to 10% by weight. This hydrogen-storage material is called Embodiment 3.

C. Hydrogen-Storing Ability of Hydrogen-Storage Material

Embodiment 1 was placed in a vessel and then heated up to 500° C. using a heater. The inside of the vessel was evacuated by vacuum and degasified at the same temperature, and thereafter Embodiment 1 was cooled so that the temperature thereof was lowered down to 25° C. which was ambient temperature.

Then, hydrogen was forced to flow into the vessel under a pressure, and when the hydrogen pressure in the vessel reached 0.1 MPa, the flow of hydrogen was stopped and the amount of hydrogen stored in Embodiment 1 was measured. In this case, the convergence time was set at 10 minutes. This convergence time also applies to Embodiments which will be described hereinafter.

Then, the degasification and the lowering of the temperature to ambient temperature, which are similar to those described above, were carried out sequentially. Then, hydrogen was forced to flow into the vessel under a pressure, and when the hydrogen pressure in the vessel reached 0.2 Pa, the flowing of hydrogen was stopped and the amount of hydrogen stored in Embodiment 1 was measured.

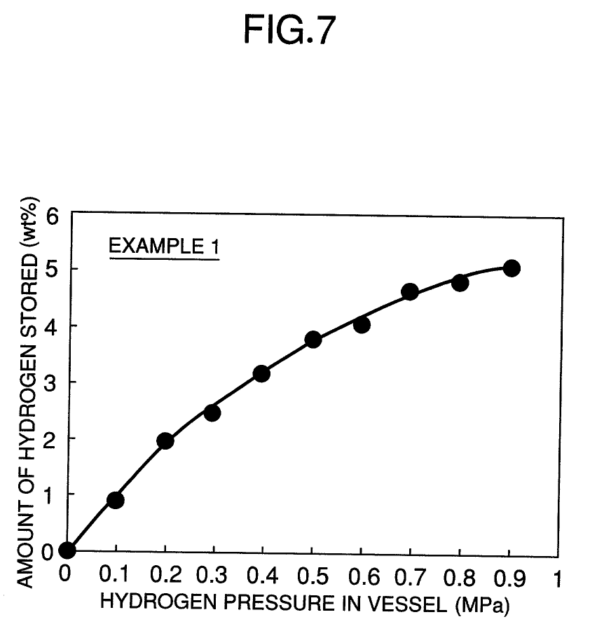

Thereafter, an operation similar to that described above, except that the hydrogen pressure in the vessel was raised 0.1 MPa by 0.1 MPa, was carried out, and the hydrogen-storing ability of Embodiment 1 was examined until the hydrogen pressure in the vessel reached 0.9 MPa, thereby providing results shown in FIG. 7.

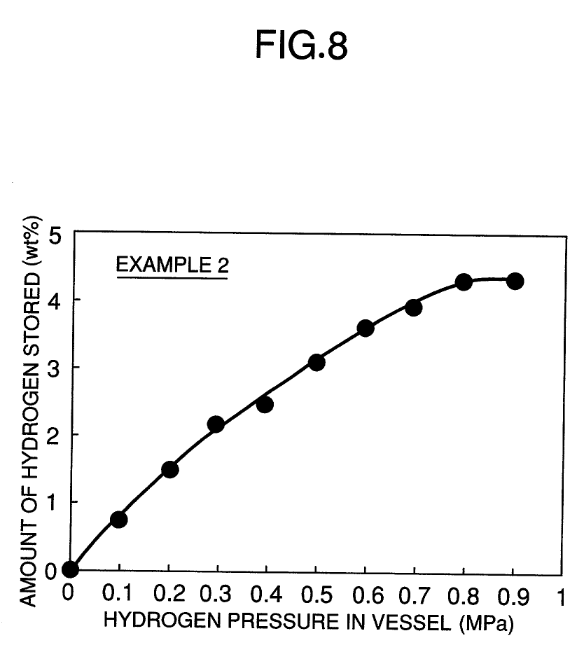

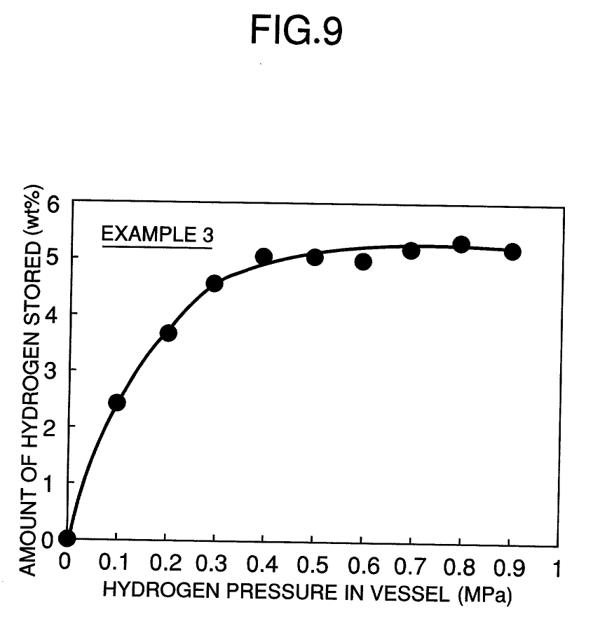

Embodiments 2 and 3 were subjected to a measurement similar to that described above under the same conditions as described above, except that the heating temperature for Embodiment 2 was set at 300° C. thereby providing results shown in FIGS. 8 and 9, respectively.

As apparent from FIGS. 7 to 9, it was ascertained that each of Embodiments 1 to 4 had a high hydrogen-storing ability and more specifically, the amount of hydrogen stored in Embodiment 1 was equal to or larger than 5% by weight at ambient temperature and under a low hydrogen pressure, namely, at 25° C. and under 0.9 MPa; the amount of hydrogen stored in Embodiment 2 was equal to or larger than 4% by weight at ambient temperature and under a low hydrogen pressure, namely, at 25° C. and under 0.8 MPa; and the amount of hydrogen stored in Embodiment 3 was equal to or larger than 5% by weight at ambient temperature and under a low hydrogen pressure, namely, at 25° C. and under 0.4 MPa.

### EXAMPLE-II

A commercially available powder comprising an aggregate of TiNi particles was subjected to ball milling in an atmosphere of argon while varying the milling time, thereby providing a plurality of powders having different average particle sizes. An average particle size d of TiNi particles was likewise calculated from the result of the TEM and SEM observation.

Then, 3 mg of each of the powders and 97 mg of carbon black were mixed together, so that the content of each powder was 3% by weight. Then, each of the resultant mixtures was subjected to a low-energy ball milling in an atmosphere of argon to provide a hydrogen-storage material which has TiNi particles serving as the fine particles and carried on the carbon black serving as the carbon carrier. It was ascertained from a thermal analysis that the amount A of TiNi particles in each of the hydrogen-storage materials was equal to 3% by weight.

One of the hydrogen-storage materials was placed into a vessel and then heated up to 550° C. using a heater. The inside of the vessel was evacuated by vacuum and degasified at the same temperature, and then the hydrogen-storage material was cooled, whereby the temperature thereof was lowered down to 25° C. which was ambient temperature.

Hydrogen was forced to flow into the vessel under a pressure, and when the hydrogen pressure in the vessel reached 1 MPa, the flow of hydrogen was stopped, and the amount of hydrogen stored in the hydrogen-storage material was measured. In this case, the convergence time was set at 10 minutes. This convergence time also applies to the following. Then, the amount of hydrogen stored in each of the remaining hydrogen-storage materials was measured in a similar manner.

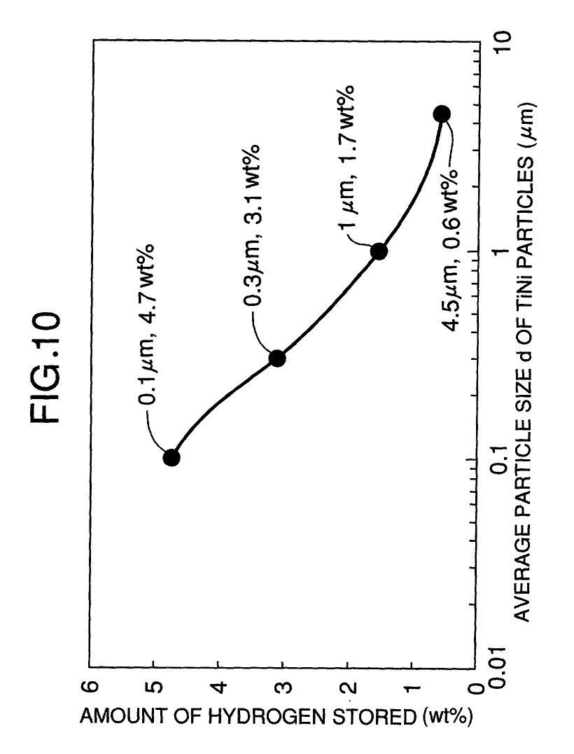

FIG. 10 shows results of the measurement. It can be seen from FIG. 10 that if the average particle size d of the TiNi particles is set at a value equal to or smaller than 1 μm (d≦1 μm), the hydrogen-absorbing amount drastically increases. This is caused by the enhancement in electron-attracting effect due to the fine particles having an average particle size d≦1 μm and the thus-increased number of the fine particles.

Although the embodiments of the present invention have been described in detail, it will be understood that the present invention is not limited to the above-described embodiments, and various modifications in design may be made without departing from the spirit and scope of the invention defined in the claims.

What is claimed is:

1. A hydrogen-storage material comprising a plurality of carbon carriers made of a carbon material having an electric conductivity, and a plurality of fine particles carried on each of said carbon carriers and having a hydrogen-adsorbing ability,
wherein the amount A of said fine particles carried is in a range of 0.1% by weight≦A≦20% by weight,
wherein said fine particles is at least one selected from fine particles of a metal, fine particles of an alloy and fine particles of an oxide semiconductor,
wherein said metal is at least one selected from the group consisting of V, Nb, Ta, Ti, Zr, Hf, La and Ce,
wherein said alloy is an alloy made of at least one selected from the group consisting of Mg, Ti, a rare earth element, Zr, V, Ca and Al and at least one selected from the group consisting of Fe, Co, Ni, Cu, Mn, Mo and W, and
wherein said oxide semiconductor is at least one selected from the group consisting of an Ni oxide semiconductor, a Cr-oxide semiconductor, a Cu-oxide semiconductor, an Mn-oxide semiconductor, an Sn-oxide semiconductor, a Zn-oxide semiconductor, a V-oxide semiconductor, a Ti-oxide semiconductor, a Co-oxide semiconductor and an Fe-oxide semiconductor.

2. A hydrogen-storage material according to claim 1, wherein the average particle size d of said fine particles is equal to or smaller than 1 μm.

3. A hydrogen-storage material according to claim 1 or 2, wherein said carbon carrier is at least one selected from the group consisting of activated carbon, carbon black, a nano-tube and fullerene.
